(19) United States
(12) Patent Application Publication
(10) Pub. No.: US 2012/0032657 A1
(43) Pub. Date: Feb. 9, 2012

(54) REDUCING SHOOT-THROUGH IN A SWITCHING VOLTAGE REGULATOR

(75) Inventor: Noel B. Dequina, Flemington, NJ (US)

(73) Assignee: INTERSIL AMERICAS INC., Milpitas, CA (US)

(21) Appl. No.: 13/110,554

(22) Filed: May 18, 2011

Related U.S. Application Data
(60) Provisional application No. 61/371,664, filed on Aug. 7, 2010.

(51) Int. Cl. G05F 1/10

(52) U.S. Cl. 323/271; 327/109

(57) ABSTRACT

Methods, apparatuses, and devices for a voltage regulator are provided. In certain examples, a method for preventing shoot-through in a voltage regulator includes determining whether an output stage for a voltage regulator is operating in a continuous-conduction mode (CCM) or a discontinuous conduction mode (DCM); and setting the voltage regulator in one of adaptive dead time mode and programmable dead time mode based on whether the output stage is operating in CCM or DCM.

### CROSS-REFERENCE TO RELATED APPLICATIONS

This application is related to U.S. provisional patent application Ser. No. 61/371,644 (attorney docket number SE-2811) entitled “REDUCING SHOOT-THROUGH IN SERIES COUPLED TRANSISTORS,” filed on Aug. 7, 2010, and referred to herein as the '644 application. The present application hereby claims the benefit of U.S. Provisional Patent Application No. 61/371,644. The '644 application is hereby incorporated herein by reference in its entirety.

### DRAWINGS

FIG. 1 is a block diagram of one example of a device comprising a voltage regulator having dual-mode gate driver providing power to a functional circuit.

FIG. 2 is a schematic diagram of one example of a voltage regulator having a dual mode gate driver.

FIG. 3 is one example of a method to reduce the possibility of shoot-through in a voltage regulator having a dual mode gate driver.

FIG. 4 is timing diagram of one example for a PWM signal as it relates to a voltage level used to drive an upper and lower transistor, a programmable dead time logical state, and an adaptive dead time logical state.

FIG. 5 is a timing diagram of one example of a logical state of a PWM signal and logical states of a lower transistor (LFET) and an upper transistor (HFET) operating according to a programmable dead time mode with a CCM PWM signal.

FIG. 6 is a timing diagram of one example of a logical state of a PWM signal and voltage levels of a lower transistor (LFET) and a phase node operating according to an adaptive dead time mode with a DCM PWM signal.

FIG. 7 is a timing diagram of one example of a logical state of a PWM signal and voltage levels of a lower transistor (LFET) and a phase node operating according to an adaptive dead time mode.

FIG. 8 is a schematic diagram of one example of an adaptive dead time circuit.

### DETAILED DESCRIPTION

A switching voltage regulator switches an upper and lower transistor on and off in order to generate an output signal of a desired voltage. As the voltage regulator toggles each transistor on or off, there is a time period after the on or off signal is provided to the transistor where the transistor is partially on, either charging or discharging, respectively. If not properly accounted for, this partially on time period can cause both the upper and the lower transistor to be at least partially on at the same time. This situation is referred to as shoot-through. Since the upper and lower transistor are coupled in series between an upper voltage and ground, shoot-through can cause a short circuit from the upper voltage to ground. This short circuit can damage the transistors and other components within and around the voltage regulator.

In order to reduce the possibility of shoot-through, a dead time can be implemented. Dead time refers to a period of time in which the switching on of one transistor is delayed after the other transistor is switched off. This dead time can allow the transistor that was switched off to fully turn off before the other transistor turns on, thus reducing the possibility of a shoot-through. As long as there is sufficient delay between the on-off transition, the possibility of both transistors being partially on at the same time is reduced.

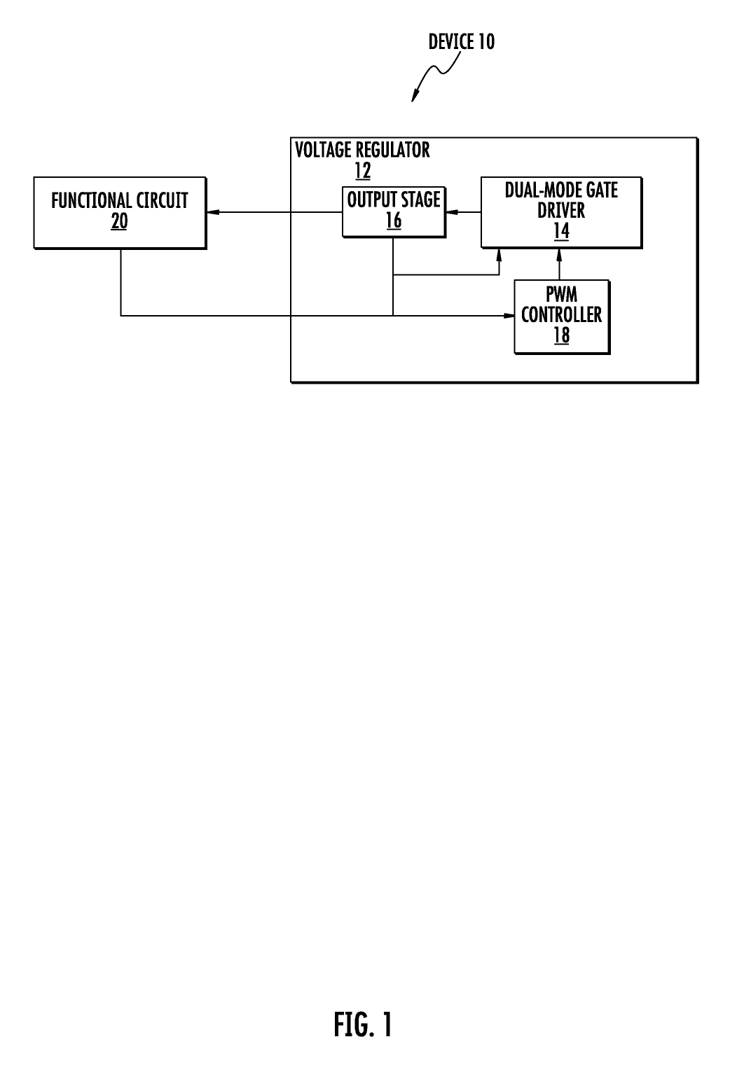

FIG. 1 is a block diagram of one example of an electronic device 10 including a switching voltage regulator 12 coupled to a functional circuit 20. The voltage regulator 12 can be configured to provide output power to the functional circuit 20. Voltage regulator 12 can include a dual mode gate driver 14 coupled to and configured to drive an output stage 16. The dual mode gate driver 14 can drive the output stage 16 according to a pulse-width modulation (PWM) scheme based on signals from a PWM controller 18. In some examples, the dual mode gate driver 14 can also receive a feedback signal from the output stage 16 to, among other things, determine the inductive current level provided by the output stage 16.

In one example, the PWM controller 18 can receive a signal from the functional circuit 20 indicating a level of output power to be provided to the function circuit 20. This level of output power can be based on, for example, the power needs of a processing device. As a function of the level of power to be provided, the PWM controller 18 can determine the appropriate PWM scheme and generate a corresponding PWM signal for the gate driver 14. The gate driver 14 can then drive the output stage 16 based on the PWM signal from the PWM controller to provide the desired level of power to the functional circuit 20. In one example, the PWM controller 18 can also receive feedback from the output stage 16 in order to regulate the output power provided to the functional circuit 16.

The dual mode gate driver 14 can control the dead time of the output stage 16 in order to reduce the possibility of shoot-through. In one example, the dual mode gate driver 14 can be set to operate in one of two dead time modes. A first dead time mode, referred to herein as a programmable dead time mode, can implement a set (e.g., by a user) dead time. In programmable dead time mode, a duration of the dead time for the upper and lower transistor can be set prior to operation of the voltage regulator 14.

A second dead time mode, referred to herein as adaptive dead time mode, can dynamically control a duration of the dead time based on the operation of the upper and lower transistors. By monitoring the operation of the upper and lower transistors, the gate driver 14 can dynamically determine the appropriate time to provide the on signal to one transistor after an off signal is provided to the other transistor.

Programmable dead time mode can be advantageous in that a dead time can be set at or near a known minimum time period in order to provide adequate shoot-through protection with maximized performance. In some instances, however, the appropriate dead time may vary based on a power scheme in which the voltage regulator 12 is operating. Thus, the dead time set by programmable dead time mode may be sufficient for a first power scheme, but may cause a shoot-through in a second power scheme. Accordingly, adaptive dead time mode can also be advantageous since adaptive dead time mode can dynamically take into account variations (e.g., different power schemes) in the voltage regulator 12 not accounted for by the programmable dead time mode.

In one example, the gate driver 14 can select a dead time mode based upon a PWM scheme in which the voltage regulator 12 is operating. In an example, the gate driver 14 can determine the PWM scheme based on the signal received from the PWM controller 18. Additional details regarding the selection of a dead time mode and operation of the dual mode gate driver 14 are provided below.

In one implementation, dual mode gate driver 14 is co-located on the same chip with output stage 16 and PWM controller 18. In another implementation, dual mode gate driver 14, output stage 16, and PWM controller 18 are located or co-located on any combination of separate or the same chips.

Examples of device 10 include a personal computer, laptop, tablet, server, mobile phone, portable music player, and other electronic devices having a voltage regulator 12. In one example, the functional circuit 20 can include one or more electrical components configured to receive power from the voltage regulator 12. In an example, the functional circuit 20 can include a processing device (e.g., a central processing unit (CPU)), a memory device, and other electrical components that are configured to receive power from the voltage regulator 12. Functional circuit 20 can also include one or more output devices (e.g., a graphics card), a communication device (e.g., a wireless transceiver), and one or more input devices. In some examples, the functional circuit can include one or more chips mounted on one or more printed circuit boards. Examples of the voltage regulator 12 can include a single phase or a multi-phase regulator.

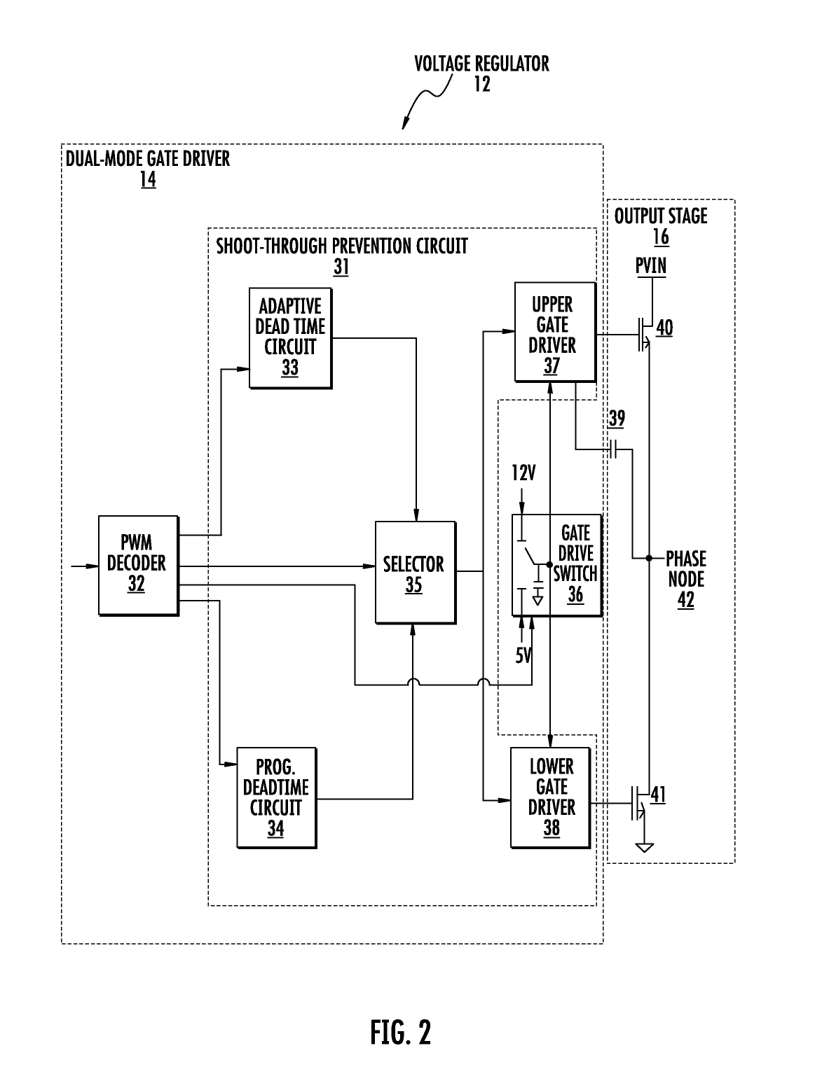

FIG. 2 is a schematic diagram of one example of the voltage regulator 12 illustrating the dual mode gate driver 14 and the output stage 16. As described above, the dual mode gate driver 14 can drive the output stage 16 based on a PWM signal from the PWM controller 18.

Dual mode gate driver 14 can include a pulse-width modulation (PWM) decoder 32, a shoot-through prevention circuit 31, and a gate drive switch 36. The shoot-through prevention circuit 31 and the gate drive switch 36 can be coupled to the PWM decoder 32. The PWM decoder 32 can decode an inputted PWM signal from the PWM controller 18 and provide signals based thereon to the shoot-through prevention circuit 31 and the gate drive switch 36. The shoot-through prevention circuit 31 and the gate drive switch 36 can control the output stage 16 based on a signal provided from the PWM decoder 32.

In an example, the shoot-through prevention circuit 31 can include an adaptive dead time circuit 33, a programmable dead time circuit 34 and a selector 35 that are coupled to the PWM decoder 32. The shoot-through prevention circuit 31 can also include an upper gate driver 37 and a lower gate driver 38 for driving an upper transistor 41 and a lower transistor 41 in the output stage 16.

In operation, the PWM decoder 32 can provide a PWM signal to an adaptive dead time circuit 33 and a programmable dead time circuit 34 based on the PWM signal received from the PWM controller 18. The adaptive dead time circuit 33 and the programmable dead time circuit 34 can provide on and off signals for an upper gate driver 37 and a lower gate driver 38 based on the PWM signal. These on and off signals can control when an upper transistor 40 and a lower transistor 41 in the output stage 16 switch on and off.

For example, if the PWM signal is at a low voltage (e.g., 0 v), the upper gate driver 37 can set the upper transistor 40 off (e.g., in non-conductive state), and the lower gate driver 38 can set the lower transistor 41 on (e.g., in a conductive state). If the PWM signal is at a high voltage (e.g., 5 v), the upper gate driver 38 can set the upper transistor 40 on, and the lower gate driver 38 can set the lower transistor 41 off. If the PWM signal is at an intermediate voltage (e.g., 2.5 v), the upper gate driver 37 can set the upper transistor 40 off and the lower gate driver 38 can control the lower transistor 41 based on whether the inductive current provided by the output stage 16. For example, the lower gate driver 38 can set the lower transistor 41 off when the inductive current from the output stage 16 crosses zero. In an example, a voltage at a phase node 42 between the upper transistor 40 and lower transistor 41 can be used to determine when the inductive current crosses zero.

The adaptive dead time circuit 33 and the programmable dead time circuit 34 can control the upper gate driver 37 and lower gate driver 38 in this manner based on the PWM signal. In an example, the selector 35 can control whether the adaptive dead time circuit 33 or the programmable dead time circuit 34 provides these on and off signals for the upper gate driver 37 and lower gate driver 38. To implement this control, the selector 35 can selectively couple either the signal from the adaptive dead time circuit 33 or the signal from the programmable dead time circuit 34 to the upper transistor 40 and the lower transistor 41.

In an example, the selector 35 can control the adaptive dead time circuit 33 and programmable dead time circuit 34 based on a signal from the PWM decoder 32. The PWM decoder 32 can determine the PWM scheme in which the output stage 16 is currently operating. In one example, the PWM decoder 32 can determine whether the PWM signal from the PWM controller 18 indicates a continuous-conduction mode (CCM) or a discontinuous-conduction mode (DCM) PWM scheme. In an example, the PWM decoder 32 can determine that the PWM signal indicates CCM when the PWM signal indicates a cycle rising from 0 v to 5 v and then decreasing from 5 v to 0 v. In an example, the PWM decoder 32 can determine that the PWM signal indicates CCM when the PWM signal indicates a cycle rising from 0 v to 2.5 v, then to 5 v, and then decreasing back to 0 v.

As mentioned above, the selector 35 can selectively couple a signal from either the adaptive dead time circuit 33 or the programmable dead time circuit 34 to the upper gate driver 37 and lower gate driver 38. This selective coupling corresponds to enabling and disabling the adaptive dead time mode and the programmable dead time mode. Enabling adaptive dead time mode includes providing the signal from the adaptive dead time circuit 33 to the upper gate driver 37 and lower gate driver 38. Likewise, enabling programmable dead time mode includes providing the signal from the programmable dead time circuit 34 to the upper gate driver 37 and lower gate driver 38. In some examples, enabling one dead time mode also includes disabling (e.g., not providing the signal to the upper gate driver 37 and lower gate driver 38) the other dead time mode. Selector 35 can determine, as set forth below, whether to enable adaptive dead time mode or programmable dead time mode based on whether the PWM decoder 32 indicates that the output stage 16 is operating in CCM or DCM.

In one example, the gate drive switch 36 can provide the upper gate driver 37 and the lower gate driver 38 with a voltage for driving the upper transistor 40 and the lower transistor 41 respectively. The gate drive switch 36 can control the upper gate driver 37 and the lower gate driver 38 based on a signal from the PWM decoder 32. If PWM decoder 32 detects CCM from the signal provided by the PWM controller 18, the PWM decoder 32 provides a signal to the gate drive switch 36 causing the gate drive switch 36 to provide a high voltage (e.g., 12 v) to the upper gate driver 37 and the lower gate driver 38. This high voltage can be used by the upper gate driver 37 and the lower gate driver 38 to switch the upper transistor 40 and the lower transistor 41 on by providing the high voltage to the respective gates of the upper transistor 40 and the lower transistor 41. Thus, the gates of upper transistor 40 and lower transistor 41 can be driven with voltages such as 12 v during CCM.

In an example, if PWM decoder 32 detects DCM from the signal provided by the PWM controller 18, the PWM decoder 32 can provide a signal to the gate drive switch 36 causing the gate driver switch 36 to provide a low voltage (e.g., 5 v) to the upper gate driver 37 and the lower gate driver 38. This low voltage can be used by the upper gate driver 37 and the lower gate driver 38 to switch the upper transistor 40 and the lower transistor 41 on by providing the low voltage to the respective gates of the upper transistor 40 and the lower transistor 41. Thus, the gates of upper transistor 40 and lower transistor 41 can be driven with a decreased voltage during DCM.

Accordingly, upper gate driver 37 and lower gate driver 38 can control the upper and lower transistors 40, 41 with different voltages depending on the PWM scheme (CCM or DCM) currently implemented. In some examples, upper gate driver 37 can use a higher voltage (e.g., 24 v) to drive upper transistor 40 than the voltage (e.g., 12 v) used by the lower gate driver 38 to drive the lower transistor 41. In such an example, a capacitor 39 in the output stage 16 can operate as a charge-pump to boost the voltage provided to upper gate driver 37. That is, the capacitor 39 can boost the voltage to the upper transistor 40 to 24 v from the initial input voltage of 12 v. In some examples, the voltage regulator 12 can also include an LC filter network coupled to the output stage 16.

In one example, DCM can be used when the functional circuit 20 is using less power (e.g., in a light load), and CCM can be used when the functional circuit 20 is using more (e.g., full power). DCM can also be used in other situations including, but not limited to when there is a polarity reversal at a switch. In an example, the voltage regulator 12 can determine the power to be provided to the functional circuit 20 based on a signal from the functional circuit 12. In an example, DCM can be used when a processing device of the functional circuit 20 operates in sleep mode with decreased functionality, while CCM can be used when the processing device operates with increased or full functionality.

Upper transistor 40 and lower transistor 41 are any type of transistor suitable for the application. In an example, upper transistor 40 and lower transistor 41 are metal-oxide-semiconductor field-effect transistors (MOSFETs) such as, but not limited to, an n-type MOSFET (NMOS) or a p-type MOSFET (PMOS). In an example, upper transistor 40 and lower transistor 41 are co-located on a single-chip along with shoot through prevention circuit 31, PWM decoder 32, capacitor 39, and gate drive switch 36. For example, upper transistor 40 and lower transistor 41 can both be located on the same semiconductor substrate, as in a complimentary metal-oxide-semiconductor (CMOS) configuration. In another example, upper transistor 40 and lower transistor 41 are disposed on separate chips.

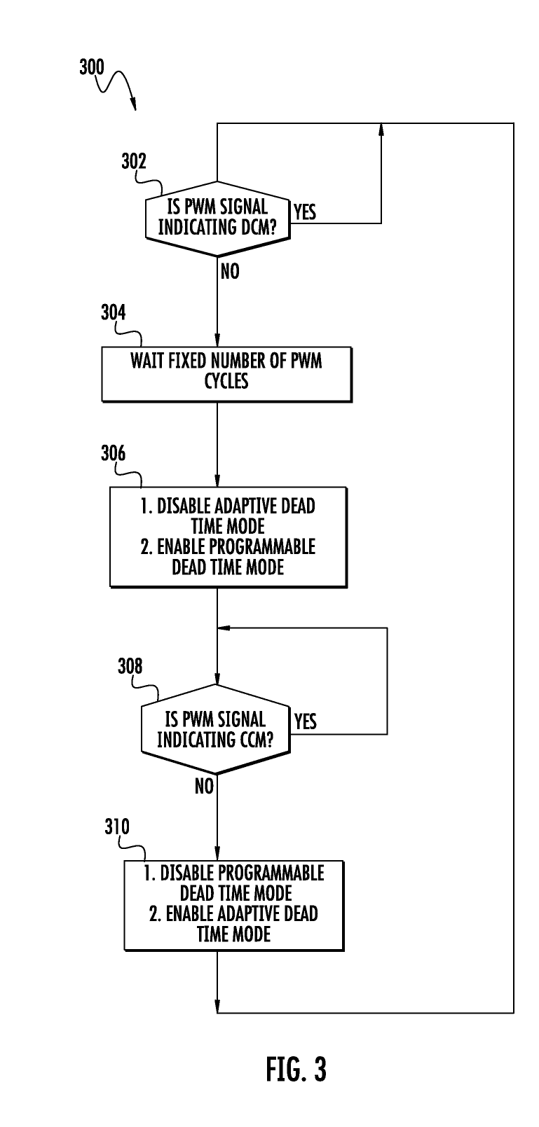

FIG. 3 is one example of a method 300 to prevent shoot-through in a voltage driver 12. The method 300 can involve selector 35 determining whether to invoke the adaptive or programmable dead time mode based upon a signal from the PWM decoder 32. The method 300 shown in FIG. 3 illustrates steady state operation of the voltage regulator 12. Accordingly, the voltage regulator 12 can be initialized (e.g., during power up) in either the adaptive dead time mode or programmable dead time mode as a default, and the method 300 can progress from the default. For example, the voltage regulator 12 can initialize with the shoot-through prevention circuit 31 in adaptive dead time mode (corresponding to block 310 of method 300). It should be understood, however, that the method 300 can operate as a continuous loop, and that the loop can be entered at varying locations depending on the default state of the voltage regulator 12. Thus, although block 302 is discussed here first, the method 300 could start at block 308 or other blocks within the method 300.

At block 302, it can be determined whether the PWM signal indicates DCM. In one example, the PWM decoder 32 can determine whether the PWM signal indicates DCM. If the PWM signal indicates DCM, the shoot-through prevention circuit 31 can remain in adaptive dead time mode and the method 300 returns to block 302. If the PWM signal does not indicate DCM then the method 300 proceeds to block 304 where a delay is implemented. To implement the delay, the shoot-through prevention circuit 31 can hold the dual mode driver 14 in the adaptive dead time mode for a period of time. In an example, the dual mode driver 14 can be held in the adaptive dead time mode for a fixed number of PWM cycles (e.g., six cycles). After the delay at block 304, the method 300 proceeds to block 306 where the shoot-through prevention circuit 31 can be switched from adaptive dead time mode to programmable dead time mode. Accordingly, at block 306, adaptive dead time mode is disabled and the programmable dead time mode is enabled by the selector 35 coupling a signal from the programmable dead time circuit 34 to the upper gate driver 37 and lower gate driver 38. Accordingly, based on the PWM decoder 32 determining that the signal from the PWM controller 18 corresponds to a mode other than DCM (e.g., CCM), the PWM decoder 32 can send a signal to selector 35 causing selector 35 to couple the signal from programmable dead time circuit 34 to the upper gate driver 37 and lower gate driver 38.

At block 308, it can be determined whether the PWM signal indicates CCM. In some examples, the PWM decoder 32 can determine whether the PWM signal indicates CCM. If the PWM signal does indicate CCM, the shoot-through prevention circuit 31 can remain in the programmable dead time mode and the method 300 can return to block 308. If the PWM signal does not indicate CCM, the method 300 can proceed to block 310 and the shoot-through prevention circuit 31 can be set to (e.g., enable) adaptive dead time mode. In one example, when the PWM decoder 32 determines that the PWM signal corresponds to DCM, the PWM decoder 32 can set the shoot-through prevention circuit 31 to adaptive dead time mode. The shoot-through prevention circuit 31 can be set to adaptive dead time mode by causing the selector 35 to couple the signal from adaptive dead time circuit 33 to the upper gate driver 37 and lower gate driver 38.

Once the shoot-through prevention circuit 31 is set to adaptive dead time mode, the method 300 can proceed to block 302 to determine whether the PWM signal indicates DCM. Accordingly, based on the PWM decoder 32 determining that the signal from the PWM controller 18 corresponds to a mode other than CCM (e.g., DCM), the PWM decoder 32 can send a signal to selector 35 causing selector 35 to couple the signal from programmable dead time circuit 34 to the upper gate driver 37 and lower gate driver 38.

In some examples, if a user has not configured (e.g., set) a dead time for the programmable dead time, then selector 35 can select adaptive dead time circuit 33 regardless of whether the PWM is in CCM or DCM.

Once the appropriate dead time mode is selected, selector 35 can provide signals to the upper gate driver 37 and lower gate driver 38 at the appropriate times based on signals from either the adaptive dead time circuit 33 or the programmable dead time circuit 34. In an example, external circuitry including a resistor can be coupled between the adaptive dead time circuit 33 and selector 35, and between programmable dead time circuit 34 and selector 35 to create a signal that triggers the upper gate driver 37 and lower gate driver 38 at the appropriate times.

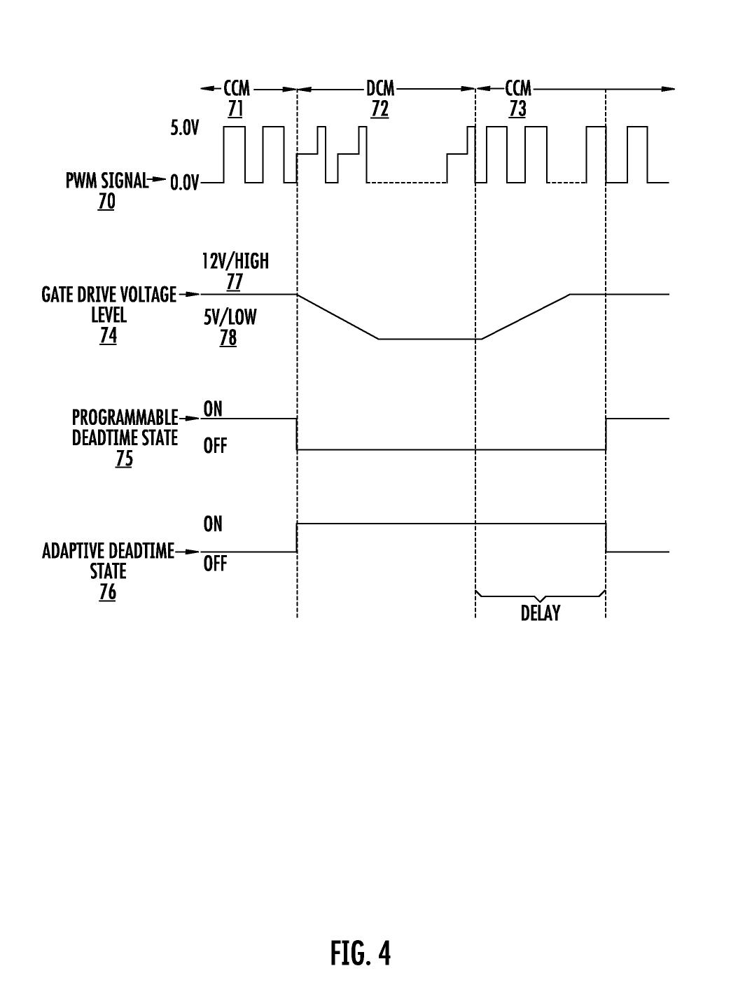

FIG. 4 is one example of a timing diagram for a PWM signal 70 as it relates to a gate drive voltage level 74, a programmable dead time logical state 75, and an adaptive dead time logical state 76 of the dual mode gate driver 14. FIG. 4 illustrates the dual mode gate driver 14 first operating in CCM 71, then transitioning to DCM 72, and then re-entering CCM 73.

During CCM 71 and CCM 73, PWM signal 70 cycles from 0 v to 5 v and back to 0 v. In one example, this signal form represents that upper gate driver 37 and lower gate driver 38 are in CCM. During DCM 72, PWM signal 70 cycles from 0 v to 2.5 v to 5 v, and then decreases to 0 v. In one example, the 0 v to 2.5 v to 5 v signal form represents upper gate driver 37 and lower gate driver 38 are in DCM.

Gate drive voltage level 74 corresponds to the voltage provided by the gate drive switch 36 to drive an upper gate driver 37 and lower gate driver 38. In one example, high voltage level 77 (e.g., 12 v) corresponds to CCM and low voltage level 78 (e.g., 5 v) corresponds to DCM. Thus, when PWM signal 70 indicates CCM (e.g., either CCM 71, or CCM 73), upper gate driver 37 and lower gate driver 38 are set to operate at high voltage level 77. When PWM signal 70 indicates DCM 72, upper gate driver 37 and lower gate driver 38 are set to operate at low voltage level 78. As shown in the diagram, the transition from high voltage level 77 to low voltage level 78 and from low voltage level 78 to high voltage level 77 is not an instantaneous change and happens over time.

Programmable dead time logical state 75 represents the logical state (e.g., enabled (ON) or disabled (OFF)) of the programmable dead time mode of the dual-mode gate driver 14 as it corresponds to a PWM signal 70. Similarly, adaptive dead time logical state 76 represents the logical state (e.g., enabled (ON) or disabled (OFF)) of the adaptive dead time mode of the dual-mode gate driver 14 as it corresponds to a PWM signal 70.

With reference to both FIGS. 3 and 4, when, at block 308, the PWM decoder 32 detects the signal form of DCM 72 from the PWM controller, the programmable dead time logical state 75 illustrates that the selector 35 disables the programmable dead time mode. Likewise, when the PWM decoder 32 detects the signal form of DCM 72 from the PWM controller the adaptive dead time logical state 76 illustrates that selector 35 enables adaptive dead time mode.

At block 302, when the PWM decoder 32 detects the signal form of CCM 73, the method 300 can implement a delay as discussed with respect to block 304. Accordingly, the programmable dead time state 75 illustrates that the selector 35 maintains the programmable dead time mode as disabled for a period of time 79. Likewise, the adaptive dead time state 76 illustrates that the selector 35 maintains the adaptive dead time mode as enabled for the period of time 79.

At block 306, after the period of time 79, the programmable dead time state 75 illustrates that the selector 35 enables the programmable dead time mode. Likewise, the adaptive dead time state 76 illustrates that the selector 35 disables the adaptive dead time mode after the period of time 79. In one example, the period of time 79 is a fixed number of PWM CCM cycles.

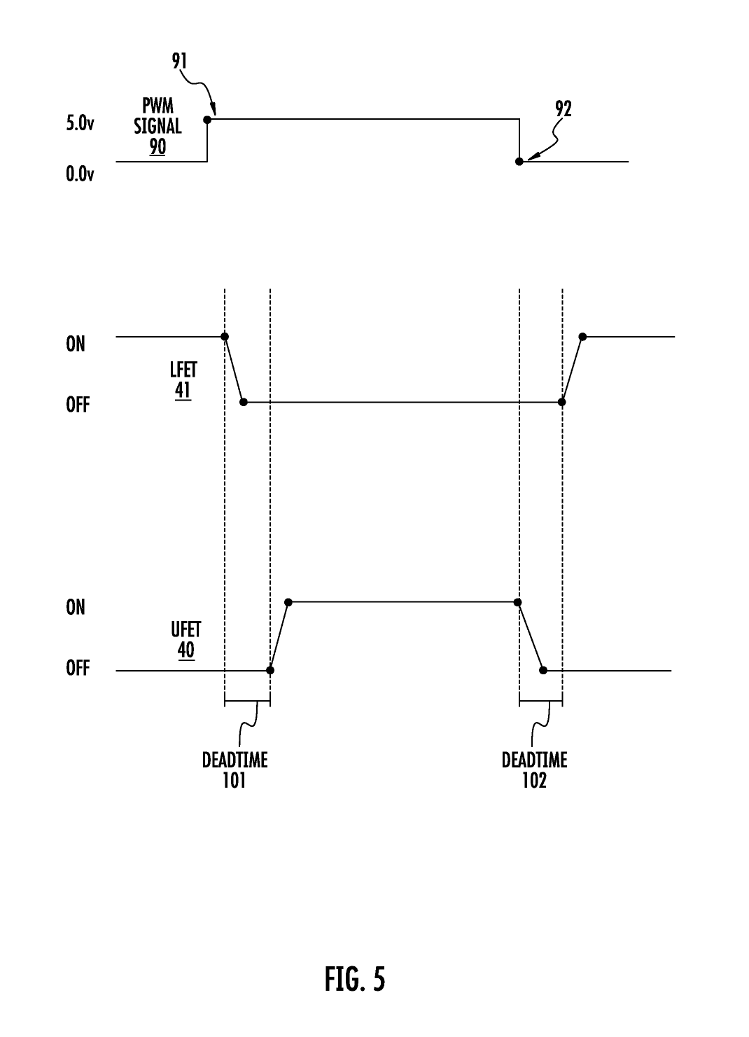

FIG. 5 is one example of a timing diagram of one example of a logical state of a PWM signal 90 and logical states of a lower transistor 41 and an upper transistor 40 operating in a programmable dead time mode. PWM signal 90 corresponds to one PWM CCM cycle that cycles from 0 v to 5 v and back to 0 v.

When PWM signal 90 rises to its highest point 91 at 5 v, a signal is provided from the programmable dead time circuit 34 to turn off the lower transistor 41. Once the signal is provided to turn off the lower transistor 41, the programmable dead time circuit 34 can implement a set duration of dead time 101 before sending the signal to turn on the upper transistor 40. Accordingly, dead time 101 corresponds to a delay in turning on upper transistor 40 after lower transistor 41 begins to turn off. In an example, the dead time 101 can be fixed across multiple (e.g., all) CCM PWM cycles. That is, the programmable dead time circuit 34 can implement the same dead time 101 each time before sending the signal to turn on the upper transistor 40 after the signal to turn off the lower transistor 41 has been sent.

When PWM signal 90 decreases to its lowest point 92 at 0 v, the programmable dead time circuit 34 can send a signal to turn off the upper transistor 40. Once the signal is provided to turn off the upper transistor 40, the programmable dead time circuit 34 can implement a set duration of dead time 102 before sending the signal to turn on the lower transistor 41. Accordingly, dead time 102 corresponds to a delay in turning on lower transistor 41 after upper transistor 41 begins to turn off. In an example, the fixed dead time 102 can be fixed across multiple (e.g., all) CCM PWM cycles. That is, the programmable dead time circuit 34 can implement the same dead time 102 each time before sending the signal to turn on the lower transistor 41 after the signal to turn off the upper transistor 40 has been sent.

In one example, the duration of dead time 101 and dead time 102 are user programmable. In one implementation of this example, the duration of the dead time 101 can be selected from one of the following fixed delays: 20 nS, 27.5 nS, or 35 nS. In another or the same implementation, the duration of the dead time 102 can be selected from one of the following fixed delays: 15 nS or 20 nS. In another example, other durations for the dead times 101, 102 are selected based upon the particular FETs and drivers being used, as well as the current being switched through the FETs and drivers.

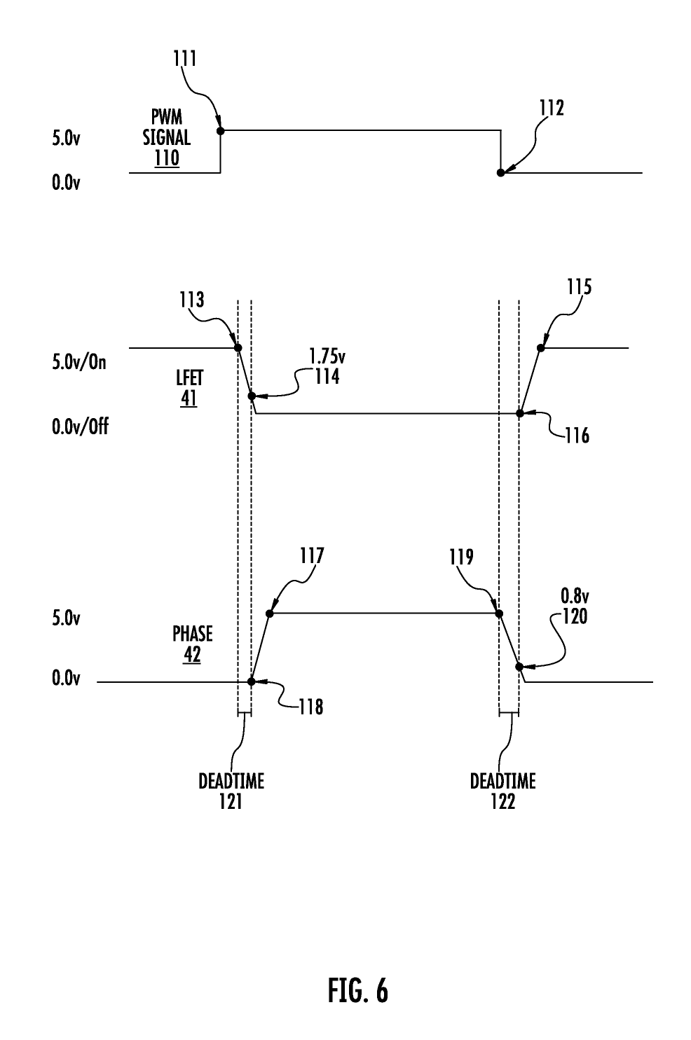

FIG. 6 is one example of a timing diagram for the dual mode gate driver 14 operating in an adaptive dead time mode 12 with a CCM PWM signal 110. FIG. 6 illustrates the logical state of a PWM signal 110, the logical state of lower transistor 41, and the voltage at the phase node 42. As mentioned above, adaptive dead time mode 12 can dynamically control dead time based on operation of the upper transistor 40 and the lower transistor 41. In particular, adaptive dead time mode 12 can control when the upper transistor 40 and the lower transistor 41 turn on based on a detected indication of when the other transistor 40, 41 is sufficiently turned off.

In an example, when the PWM signal transitions 111 to high voltage (e.g., 5 v), the adaptive dead time circuit 33 sends a signal to turn off the lower transistor 41. Once the signal is provided to turn off the lower transistor 41, the adaptive dead time circuit 33 can implement a dynamic duration for dead time 121 before sending the signal to turn on the upper transistor 40. To implement the dynamic duration for dead time 121, the adaptive dead time circuit 33 can detect the voltage level at the gate of the lower transistor 41. The voltage level at the gate of the lower transistor 41 drops from a high voltage 113 (e.g., 5 v) to a threshold 114 (e.g., 1.75 v), the adaptive dead time circuit 33 can send a signal to turn on the upper transistor 40. Turning on the upper transistor 40 causes the voltage at the phase node to rise from a low voltage 118 (e.g., 0 v) to a high voltage 117 (e.g., 5.0 v). Thus, the duration of dead time 121 is dynamic since the duration may vary from one PWM cycle to the next based on how long it takes the lower transistor 41 to drop to 1.75 v.

In an example, when the PWM signal transitions 112 to low voltage (e.g., 0 v), the adaptive dead time circuit 33 sends a signal to turn off upper transistor 40. Once the signal is provided to turn off the upper transistor 40, the adaptive dead time circuit 33 can implement a dynamic duration for dead time 122 before sending the signal to turn on the lower transistor 41. In an example, to implement the dynamic duration for dead time 122, the adaptive dead time circuit 33 can detect the voltage level at the phase node 42. Turning off the upper transistor 41 causes the voltage level at the phase node 42 to drop from a high voltage 119 (e.g., 5 v) to a threshold 120 (e.g., 0.8 v). When the voltage at the phase node 42 drops to the threshold 120, the adaptive dead time circuit 33 can send a signal to turn on the lower transistor 41. Turning on lower transistor 41 causes the voltage at the gate of the lower transistor 41 to rise from a low voltage 116 (e.g., 0 v) to a high voltage 115 (e.g., 5.0 v). Thus, the duration of dead time 122 is dynamic since the duration may vary from one PWM cycle to the next based on how long it takes the phase node 42 to drop to 0.8 v. In another example, the adaptive dead time circuit can control when the lower transistor 41 is turned on in a similar manner based on the voltage at the gate of the upper transistor 40.

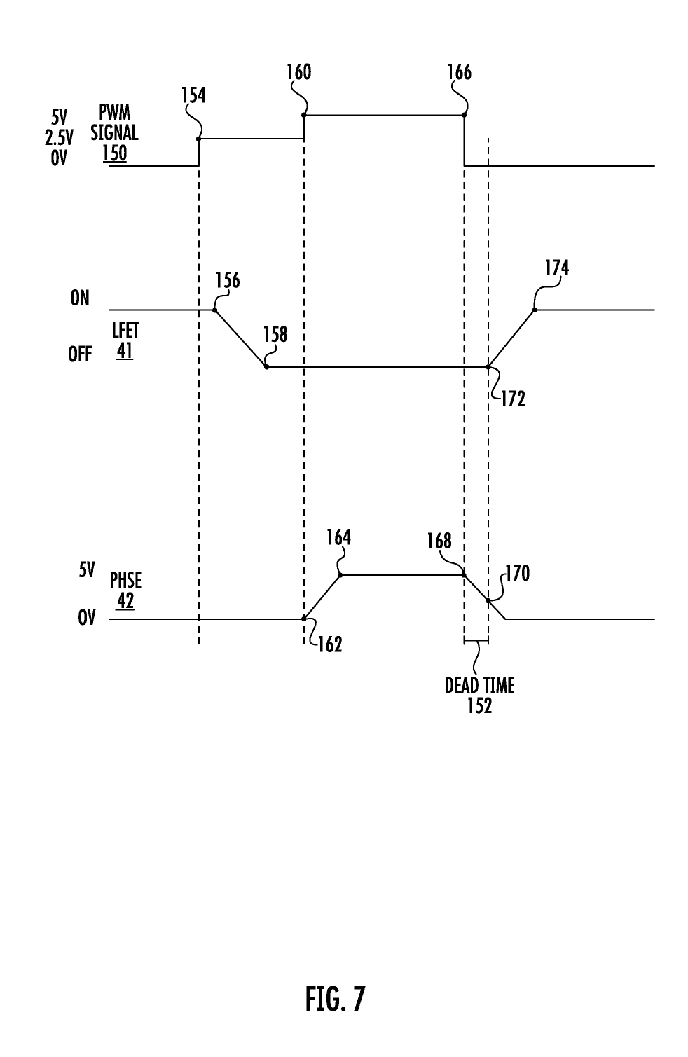

FIG. 7 is one example of a timing diagram for the dual mode gate driver 14 operating in an adaptive dead time mode 12 with a DCM PWM signal 150. FIG. 7 illustrates the logical state of a PWM signal 150, the logical state of lower transistor 41, and the voltage at the phase node 42.

In an example, when the PWM signal 150 indicates DCM, the adaptive dead time circuit 33 implements a dynamic dead time 152 before turning on the lower transistor 41. In an example, a dynamic dead time for turning on the upper transistor 41 is not used since the lower transistor 40 will likely be turned off in plenty of time before the upper transistor 41 is to turn on in accordance with the DCM PWM scheme.

For example, when the PWM signal 150 transitions 154 to an intermediate voltage (e.g., 2.5 v), the adaptive dead time circuit 33 can control the lower transistor 41 in accordance with the DCM PWM scheme. That is, the lower transistor 41 remains on until the inductive current from the output stage 16 crosses zero. When the inductive current crosses zero, the lower transistor 41 is turned off. Turning off the lower transistor 41 causes the voltage at the gate of the lower transistor 41 to drop from a high voltage 156 (e.g., 5 v) to a low voltage 158 (e.g., 0 v). Once the lower transistor 41 is turned off, both the lower transistor 41 and the upper transistor 40 remain off until the PWM signal 150 transitions 160 to a high value (e.g., 5 v). Here, the upper transistor 40 is turned on which causes the voltage at the phase node 41 to rise from a low voltage 162 (e.g., 0 v) to a high voltage 164 (e.g., 5 v).

Once the upper transistor 40 is turned on with the PWM signal 150 at a high value, the adaptive dead time circuit 33 controls the dynamic dead time 152 in the same manner as described with respect to FIG. 6. Accordingly, when the PWM signal 150 transitions 166 to low voltage (e.g., 0 v), the adaptive dead time circuit 33 sends a signal to turn off upper transistor 40. Once the signal is provided to turn off the upper transistor 40, the adaptive dead time circuit 33 can implement a dynamic duration for dead time 152 before sending the signal to turn on the lower transistor 41. In an example, to implement the dynamic duration for dead time 152, the adaptive dead time circuit 33 can detect the voltage level at the phase node 42. Turning off the upper transistor 41 causes the voltage level at the phase node 42 to drop from a high voltage 168 (e.g., 5 v) to a threshold 170 (e.g., 0.8 v). When the voltage at the phase node 42 drops to the threshold 120, the adaptive dead time circuit 33 can send a signal to turn on the lower transistor 41. Turning on lower transistor 41 causes the voltage at the gate of the lower transistor 41 to rise from a low voltage 172 (e.g., 0 v) to a high voltage 174 (e.g., 5.0 v). Thus, the duration of dead time 152 is dynamic since the duration may vary from one PWM cycle to the next based on how long it takes the phase node 42 to drop to 0.8 v. In another example, the adaptive dead time circuit can control when the lower transistor 41 is turned on in a similar manner based on the voltage at the gate of the upper transistor 40.

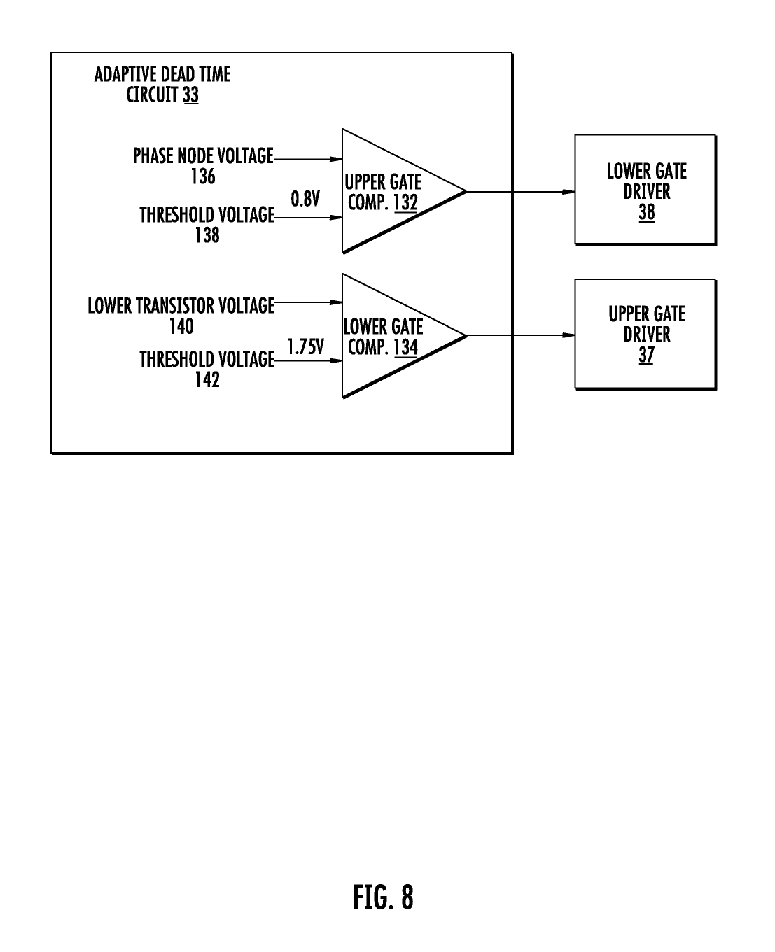

FIG. 8 is a schematic diagram of one implementation of an adaptive dead time circuit 33. Adaptive dead time circuit 33 can include an upper gate comparator 132 receiving a threshold voltage 138 at a first input and a phase node voltage 136 at a second input. The threshold voltage 138 can be used to determine when to turn on the lower gate driver 38. Adaptive dead time circuit 33 can also include a lower gate comparator 134 receiving a threshold voltage 142 at a first input for determining when to turn on the upper gate driver 37 when the gate driver 14 is operating in CCM. Comparators 132 and 134 enable or disable lower gate driver 38 and upper gate driver 37, respectfully, based upon reaching fixed threshold voltages. In one example, the voltage of the threshold voltage 142 that toggles the upper gate driver 37 is 1.75 v. Similarly, the voltage of the threshold voltage 138 that toggles the lower gate driver 38 is 0.8 v. In another example, the specific threshold voltage levels that are used are selected to be other voltages based upon the particular transistors and drivers being used, as well as the current being switched through the transistors and drivers.

Some examples described herein reduce shoot-through in series coupled transistors by adjusting dead time through selecting either a fixed programmable dead time or an adaptive dead time. Examples of the dual mode scheme described herein can also be used in, for example, a DC-DC converter, a half-bridge rectifier, or a full-bridge rectifier.

A number of examples of the invention defined by the following claims have been described. Nevertheless, it will be understood that various modifications to the described examples may be made without departing from the spirit and scope of the claimed invention. Features and aspects of particular examples described herein can be combined with or replace features and aspects of other examples. Accordingly, other examples are within the scope of the following claims.

What is claimed is:

1. A method for preventing shoot-through in a voltage regulator, the method comprising:
determining whether an output stage for a voltage regulator is operating in a continuous-conduction mode (CCM) or a discontinuous conduction mode (DCM); and
setting the voltage regulator to one of an adaptive dead time mode and a programmable dead time mode based on whether the output stage is operating in CCM or DCM.

2. The method of claim 1, wherein setting includes setting the voltage regulator to adaptive dead time mode based on determining that the output stage is in DCM.

3. The method of claim 1, wherein setting includes setting the voltage regulator to programmable dead time mode based on determining that the output stage is in CCM.

4. The method of claim 1, comprising:
holding the voltage regulator in adaptive mode for a period of time after determining that the output stage has switched from DCM to CCM; and
wherein setting includes setting the voltage regulator in programmable dead time mode after holding the voltage regulator in adaptive mode for a period of time.

5. The method of claim 4, comprising:
wherein holding includes holding for a predetermined number of pulse-width modulation cycles.

6. The method of claim 1, wherein programmable dead time mode corresponds to output stage cycles having a fixed duration of dead time.

7. The method of claim 1, wherein adaptive dead time mode corresponds to output stage cycles having dynamically changing duration of dead time based on the voltage at a phase node between an upper transistor and a lower transistor of the output stage.

8. A gate driver for driving an output stage of a voltage regulator, the gate driver comprising:
an upper gate driver;
a lower gate driver;
a programmable dead time circuit that is operable to implement a set duration of dead time;
an adaptive dead time circuit that is operable to dynamically control a duration of dead time based upon the voltage at a phase node of the output stage; and
a selector coupled to the programmable dead time circuit and the adaptive dead time circuit that selects between coupling the programmable dead time circuit or the adaptive dead time circuit to the upper gate driver and the lower gate driver based on an inputted PWM signal.

9. The gate driver of claim 8, wherein the selector is operable to:
couple the adaptive dead time circuit to the upper gate driver and the lower gate driver based on an indication from the inputted PWM signal that the output stage is operating in discontinuous-conduction mode (DCM).

10. The gate driver of claim 8, wherein the selector is operable to:
couple the programmable dead time circuit to the upper gate driver and the lower gate driver based on an indication from the inputted PWM signal that the output stage is operating in continuous-conduction mode (CCM).

11. The gate driver of claim 8, wherein the selector is operable to:
hold the adaptive dead time circuit as coupled to the upper gate driver and the lower gate driver for a period of time after determining that the output stage has switched from discontinuous-conduction mode (DCM) to continuous-conduction mode (CCM); and
couple the programmable dead time circuit to the upper gate driver and the lower gate driver based on an indication from the inputted PWM signal that the output stage is operating in continuous-conduction mode (CCM) after holding the adaptive dead time circuit as coupled to the upper gate driver and the lower gate driver.

12. The gate driver of claim 11, wherein the selector is operable to hold the adaptive dead time circuit as coupled to the upper gate driver and the lower gate driver for a predetermined number of pulse-width modulation cycles after determining that the output stage has switched from discontinuous-conduction mode (DCM) to continuous-conduction mode (CCM).

13. The gate driver of claim 8, wherein the programmable dead time circuit is operable to implement a fixed duration of dead time across multiple PWM cycles.

14. The gate driver of claim 8, comprising:
a gate drive switch operable to provide a first voltage to the upper gate driver and the lower gate driver when the inputted PWM signal indicates that the output stage is operating in continuous-conduction mode (CCM) and operable to provide a second voltage to the upper gate driver and the lower gate driver when the inputted PWM signal indicates that the output stage is operating in discontinuous-conduction mode (DCM), wherein the first voltage is higher than the second voltage.

15. The gate driver of claim 8, wherein the upper gate driver is operable to turn an upper transistor on and off based on the inputted PWM signal; and
wherein the lower gate driver is operable to turn a lower transistor on and off based on the inputted PWM signal.

16. An electronic device comprising:
a functional circuit; and
a voltage regulator operable to provide power to the functional circuit, the voltage regulator comprising:
an output stage configured to provide power to the functional circuit; and
a gate driver configured to drive the output stage according to a pulse-width modulation (PWM) scheme, wherein the gate driver is configured to implement a first dead time mode as a function of the gate driver implementing a first PWM scheme and a second dead time mode as a function of the gate driver implementing a second PWM scheme, wherein the first dead time mode is configured to implement a set duration of dead time and wherein the second dead time mode is configured to implement a dynamic duration of dead time.

17. The electronic device of claim 16, wherein the gate driver is configured to implement the first dead time mode based on an indication that the PWM scheme is a continuous-conduction mode (CCM); and
wherein the gate driver is configured to implement the second dead time mode based on an indication that the PWM scheme is discontinuous-conduction mode (DCM).

18. The electronic device of claim 17, wherein the gate driver is configured to:
hold in the second dead time mode for a period of time after receiving the indication that the PWM scheme is a continuous-conduction mode (CCM); and
implement the first dead time mode after the period of time.

19. The electronic device of claim 16, wherein the functional circuit is configured to provide an indication of an output power to be provided by the voltage regulator, and wherein the PWM scheme is selected as a function of the output power to be provided.

20. The electronic circuit of claim 19, wherein the functional circuit includes a processing device and a memory device, and wherein the indication of the output power can be provided based whether the processing device is in a sleep mode.
